(19) United States
(12) Patent Application Publication
(10) Pub. No.: US 2012/0268398 A1
(43) Pub. Date: Oct. 25, 2012

(54) DISPLAY INPUT APPARATUS

(75) Inventor: Kazunori Kato, Izu-shi (JP)

(73) Assignee: TOSHIBA TEC KABUSHIKI KAISHA, Tokyo (JP)

(21) Appl. No.: 13/430,964

(22) Filed: Mar. 27, 2012

(30) Foreign Application Priority Data
Apr. 25, 2011 (JP) 2011-096969

(51) Int. Cl. G06F 3/041

(52) U.S. Cl. 345/173

(57) ABSTRACT

A display input apparatus that a display panel having a touch panel for input on a display unit rotationally install to a main body unit, comprise an opposite object sensor configured to detect which is facing the display unit of the display panel, the first user or the second user, and switch the content displayed on the display panel according to the detection result of the opposite object sensor.

### CROSS-REFERENCE TO RELATED APPLICATION

This application is based upon and claims the benefit of priority from Japanese Patent Application No. 2011-096969, filed Apr. 25, 2011, the entire contents of which are incorporated herein by reference.

### FIELD

Embodiments described herein relate to a display input apparatus, for each user which are facing each other make a display unit of a display panel possible to face.

### BACKGROUND

At present, so-called POS system is widely used to manage a sales information management in a shop. The terminal of such a POS system that may displays an information, and a customer and a store clerk face each other may see and operate a panel used to display and input for input each other has been widely used. That is, there is an apparatus having two displays and two sound output units facing an operator (store clerk) and a customer.

However, such apparatus needs a plurality of displays and sound output units, then become larger in size. Thus, the problem is that an installation site of a larger space needs, further, compare with the apparatus of one display and one sound output unit cost may be about 2 times more expensive. In addition, due to the occasional synchronous output of two or more sounds which cause interference to each other, it is hard to hear the sounds.

To such problem, there is the display panel of the terminal apparatus that use one display panel, is rotationally installed with respect to a main body unit through a support arm and the customer facing angle and the store clerk facing angle of which can be changed by rotating the support arm (referring to Patent Document 1).

In such terminal apparatus, when the operator (store clerk) operates, positions the display unit of the display panel at an angle easy for the operation. Besides, when it is desired to display the content on the display panel for the customer, the arm is rotated to make the display unit of the display panel inclined significantly to face the customer.

### BRIEF DESCRIPTION OF THE DRAWINGS

FIG. 1 is a functional block diagram illustrating the function of a display input apparatus according to an embedment;

FIG. 2 is an outline oblique view showing the display input apparatus under a normal usage status according to the embedment;

FIG. 3 is an outline side view showing the display input apparatus under the normal usage status according to the embedment;

FIG. 4 is an outline side view showing the usage status of the display input apparatus when displays for a customer according to the embedment;

FIG. 5 is a perspective view showing the situation that install an opposite object sensor in the display input apparatus according to an embedment.

### DETAILED DESCRIPTION

According to one embodiment, a display input apparatus, rotationally set a display panel having a touch panel for input on a display unit and for a first user and a second user which are facing each other make the display unit of the display panel possible to face the first user and the second user by rotating the display panel, comprises: an opposite object sensor configured to detect which is facing the display unit of the display panel, the first user or the second user; and a main body unit configured to switch the content displayed on the display panel according to the detection result of the opposite object sensor.

An embodiment is described below with reference to accompanying drawings.

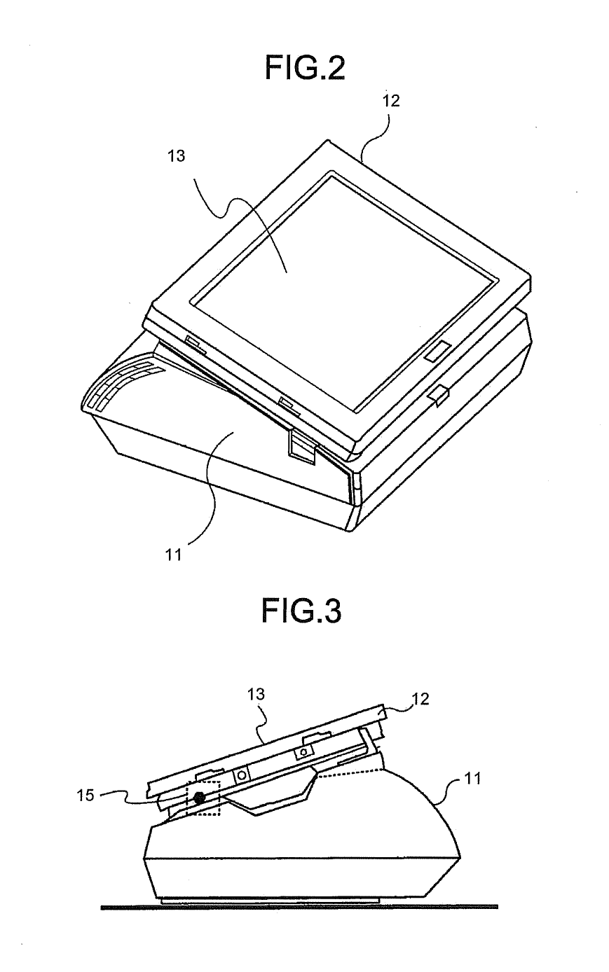

An outline forming of the display input apparatus disclosed in this embodiment is described first with reference to FIG. 2-FIG. 5.

The display input apparatus is used in a POS terminal, comprises a main body unit 11 in which various control functions described later are provided and a display panel 12 configured on the main body unit 11. The display panel 12 may be, for example, a liquid crystal display panel. The display panel 12 has a rectangular display unit on which a touch panel 13 for input is configured.

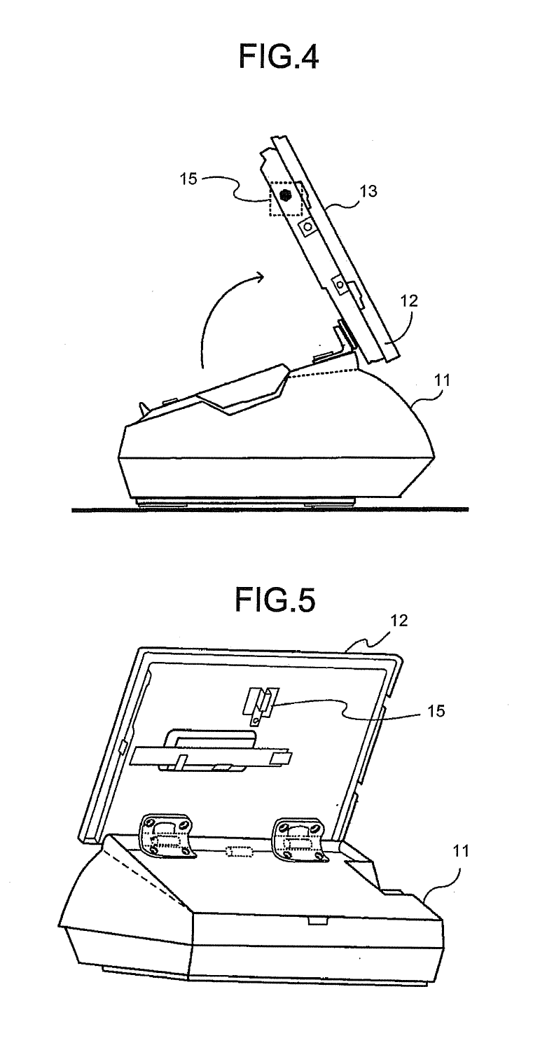

Further, the display panel 12 is set at a given angle of inclination with respect to the main body unit 11, as shown in FIG. 2 and FIG. 3, and rotationally installed with respect to the main body unit 11, as shown in FIG. 4 and FIG. 5. Moreover, the display unit of the display panel 12 can be oppositely positioned to face opposite users (operator (store clerk) and customer) by rotating the display panel 12. That is, the input display apparatus shown in FIG. 2 and FIG. 3 is the situation under the normal usage status (the first usage status), in which the display unit of the right upwards-inclined display panel 12 shown in FIG. 3 faces the operator (the first user) not shown on the left side of FIG. 3. In this case, as shown in FIG. 4, the display panel 12 can be clockwise rotated by a given angle to make the display unit in a customer display state (the second usage status) to face the customer (the second user) not shown on the right side of FIG. 4.

An opposite object sensor 15 is configured on the back of the display panel 12, as shown in FIG. 5. The opposite object sensor 15 detect which is facing the display unit of the display panel 12, the first user or the second user, that is, detect that the display unit of the display panel 12 faces the first user under the first usage status or the second user under the second usage status.

The opposite object sensor 15 may be, for example, a gravity sensor. That is, the opposite object sensor 15 may be a apparatus having a shielding object moving under the effect of gravity according to the change in the usage status of the display panel 12 and a sensor unit changing an output with the vertical movement of the shielding object. In this gravity sensor, when the display panel 12 is in the first usage status shown in FIG. 2 and FIG. 3, if the shielding object below the sensor mechanism enters into the second usage status shown in FIG. 4 and FIG. 5 due to the effect of gravity, then the shielding object moves on the upper part of the sensor mechanism under the effect of gravity to shield the light-transmitting sensor and output a detection signal.

Further, the opposite object sensor 15 is not limited to the aforementioned gravity sensor and may be a so-called angular sensor which detects the rotation angle of the display panel 12.

Further, as the display unit of the display panel 12 is turned vertically in the first and second usage status, the screen displayed in the display unit is also turned vertically. The turning of the displayed screen is carried out using a well-known method according to the detection signal of the opposite object sensor 15.

The display input apparatus is structured as follows: the display unit of the display panel 12 can be oppositely positioned to face opposite users. In this case, the display of the same screen to different users will cause a problem in confidential information management, as stated above. Therefore, in embodiments described herein, the content displayed on the display unit is changed according to the direction the display unit faces, thereby implementing an appropriate display for a display object (the first or second user).

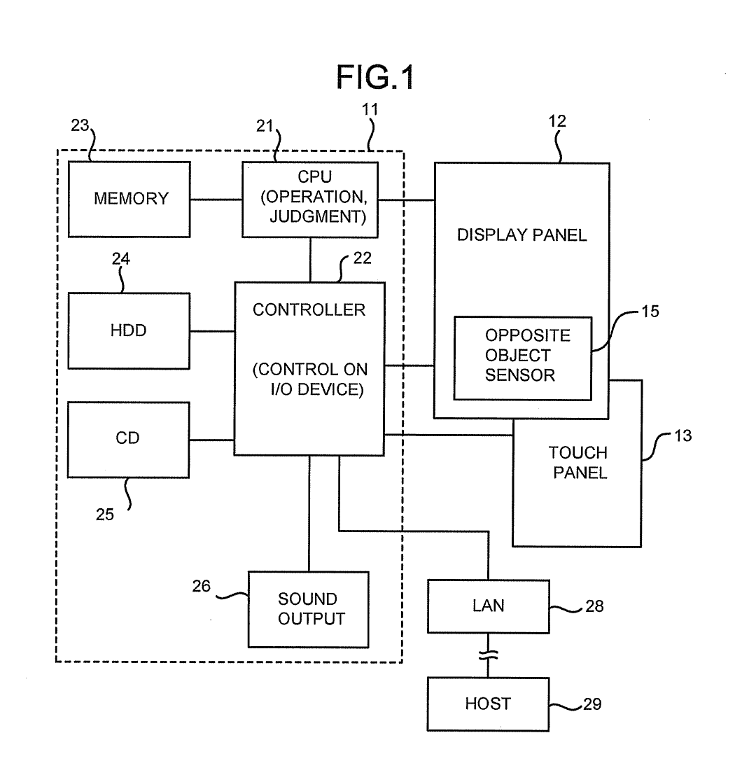

The control unit of the display input apparatus having a switch control function of changing the content displayed on the display unit according to the direction the display unit faces is described below with reference to FIG. 1.

FIG. 1 is a functional block diagram illustrating the function of a display input apparatus according to an embedment. In FIG. 1, the display panel 12 has a touch panel 13 that is configured on the surface of a rectangular liquid crystal display unit and an opposite object sensor that is configured on the back of the display panel 12, as shown in FIG. 5.

On the other hand, a CPU 21, a controller 22, a memory 23, an HDD (Hard Disk driver) 24, a CD system 25 and a sound output unit 26 are configured on the main body unit 11. Further, the controller 22 is connected with a main system 29 via an LAN (Local Area Network) 28.

The CPU 21 executes various operations or determinations using the data or OS temporality stored in the memory 22 according to a preset program, and outputs the results of the operations or determinations to the display panel 12. Data or OS is temporality stored in the memory 22 and removed once the power supply is cut off. The controller 2 controls the input and output of the controller 22, the memory 23, the HDD 24, the. CD system 25, the sound output unit 26 as well as the input and the output of the touch panel 13, the opposite object sensor 15 and the LAN 28 with respect to the CPU 21.

Here, the screen data displayed on the OS or display panel 12 and the data desired to be stored are stored in the hard disk of the HDD 24. The CD 25 is used for the installation or maintenance of kinds of data. The sound output unit 26 outputs a sound corresponding to the content displayed on the display panel 12 or an input operation, for example, the sound output unit 26 outputs a buzzing sound corresponding to an input operation during a settlement processing, for another example, in the case where a customer display advertisement is offered, the sound output unit 26 outputs a sound corresponding to the content of the advertisement.

The touch panel 13 is an apparatus detecting the input operation of a user corresponding to an input button image displayed on the display unit of the display panel 12 at each predetermined coordinate position and inputs the detected coordinate signal to the controller 22. The opposite object sensor 15 is installed on the back side of the display panel 12, as shown in FIG. 5, to detect which one of opposite users the display panel 12 faces. Moreover, the detection signal is input to the controller 22.

In the embodiments described herein, the content displayed on the display unit is changed according to the direction the display panel 12 faces. Moreover, the switch control on the displayed content and the accompanying sound output is carried out according to the detection signal sent from the opposite object sensor 15. Further, there exists a case in which the display unit is turned vertically according to the opposite directions of the display panel 12, and the turning control on the display screen during the turning of the display unit and the input detected coordinate of the corresponding touch panel 13 is also carried out according to the detection signal sent from the opposite object sensor 15.

The main system 29 is an apparatus that is connected with the main body unit 11 via the LAN 28 to store the settlement data or customer data processed by the main body unit 11 with respect to an input operation on the touch panel 13 and the content displayed on the display panel 12 for the customer.

The main body unit 11 of the display input apparatus described in this embodiment changes the content displayed on the display panel 12 according to the detection result of the opposite object sensor 15, as stated above. For example, the main body unit 11 displays a display screen different from the display screen faces the operator on the display unit if the opposite direction of the display unit of the display panel 12 change from the operator side (that is the first side) to customer side (that is the second user side).

In an example of this embodiment, it is assumed that the operator operates a settlement screen (touch panel 13) displayed on the display unit of the display panel 12 in the state shown in FIG. 2 and FIG. 3 to carry out a settlement processing on the sold commodities. At this time, the operator needs to make sure that the settled content is clearly seen and confirmed by the customer. Therefore, the display panel 12 is rotated to make the display unit face the customer, as shown in FIG. 4.

Here, detailed customer data including the password and other confidential information of the credit card of the customer is usually displayed in a settlement processing screen for customer use.

In this case, when customer confirms the settled content, it is enough simply to display the relationship between a commodity and a price and the content related to a payment method, not display detailed customer data including confidential information on the screen to show customer so that a third party other than the relevant customer would not see the confidential information. That is, if the state of the display unit of the display panel 12 changes from an operator-facing state to a customer-facing state is detected by the opposite object sensor 15, then change from a settlement screen for operator use to a settlement screen for customer use excluding items concerning the confidential information.

Specifically, for example, a software may be assembled in such a manner that a table is preset in which a plurality of items A, B, C and D are preset as the information forming a display screen and items A, B and C including the confidential information item B are displayed for an operator, and items A, C and D including the advertisement information item D are displayed for a customer.

As seen from above, a display screen different from the display screen in the case that the display unit faces the operator is displayed on the display unit if the opposite direction of the display unit of the display panel 12 change from the operator side to the customer side. In this case, may also display a screen containing prepared advertisement content.

The above description is the case that the display unit of the display panel 12 displays the settlement content for a specific customer, however, there is the case in which commodity information and the like is displayed for most customers exclusive of the specific ones. In this case, by the opposite object sensor 15 may detect the display unit of the display panel 12 facing a customer side, may also display the content that is prepared to be displayed to a customer. At this time, sound information corresponding to the contained advertisement content is output from the sound output unit 26.

Further, the main body 11, when the display unit of the display panel 12 faces is changed to a customer side from an operator side, set the brightness of the case that the display unit faces the customer side higher than the case that the display unit faces the operator side.

In general, the illumination for the customer position is well-lighted in comparison with the illumination for the operation position of the operator,

Thus, by the opposite object sensor 15 may detect the display unit of the display panel 12 facing a customer side and turn the brightness up. Thus, by using the brightness suitable for the surrounding environment, therefore, may realize a good display.

Further, when the display unit of the display panel 12 faces a customer side, the main body unit 11 makes the display area of the input button of the touch panel 13 of the case that the display unit faces the customer side bigger than the case that the display unit faces the operator side, and makes the input scan line of the touch panel 13 sparse if the display unit faces the second user side.

For example, when make the customer select the method of payment: in cash or with a credit card, display a selection button on the display unit of the display panel 12 facing the customer, and an input point on the touch panel 13 corresponding to the selection button is press-operated.

In this case, in order to facilitate the operation of the customer, the display area of the input button is set to be larger than the case that the display unit of the display panel 12 faces the operator side. Further, as seen from above, the display area of the input button is set to be larger, thus, no needs to execute the microscopic operation, so there is no problem to sparse the input scan line, the main body 11 controls to sparse the input scan line of the touch panel 13, thus, This way the power consumption may be reduced. Under the components is described above, the display input apparatus described in this embodiment as the terminal of a POS terminal used in a shop is described below.

The POS terminal used between a customer and a store clerk in such a form enables the customer and the store clerk to see each other, and through the display panel of the POS terminal executes a displaying of advertisement information or a settlement processing for the sold commodities or a confirmation for the settlement processing and the like.

Under the status of using this embodiment, when the POS terminal is operated by the operator (store clerk), is the normal usage status (the first usage status) shown in FIG. 2 and FIG. 3. When in this usage status, the display panel 12 is configured on the main body unit 11, with the display unit thereof facing the operator of the left side of FIG. 3, and is positioned at an angle easy for the operation of the operator. Under the normally usage status, the operator through the settlement screen displayed on the display unit, operates the touch panel 13 set on the surface of the display unit, executes a settlement processing accompanying a commodity selling.

To have the customer confirm the settlement content, rotates the display panel 12, as shown in FIG. 4, the display unit is greatly inclined to face the opposite customer (on the right side of FIG. 4). In this way, if the state of the display unit of the display panel 12 is changed to the second usage status (customer-facing status), then the opposite object sensor 15 detects this change and switches the content displayed on the display unit from an settlement operating screen by the operator to a screen for customer. That is, a screen is displayed in which the confidential information of the customer is removed from the operating screen by the operator and advertisement information is combined. The customer visual checks and confirms the display content and, if needed, operates the input button displayed on the screen to input an operation signal to a corresponding coordinate point of the touch panel 13.

Further, that is not the case that the settlement processing is displayed, is the case that the advertisement information containing the commodity information is displayed for many unspecified consumers displays, if the state of the display unit of the display panel 12 is changed to the second usage status (customer-facing status), the opposite object sensor 15 detects this change, displays a preset customer display content on the display unit, and outputs corresponding sound information from the sound output unit 26.

Further, when the state of the display unit of the display panel 12 is changed to the second usage status (customer-facing status), a control is carried out to increase the brightness of the display unit according to the detection signal of the opposite object sensor 15 to realize an optimal display at a brightness corresponding to the surrounding environment.

Further, as stated above, when the display unit of the display panel 12 is in the second usage status (customer-facing status), an input button is displayed on a screen carry out an operation based on the selection of a customer, and when the touch panel 13 configured on the surface of the display unit is operated, make the display area of the input button large to facilitate the operation of the customer. Thus, as description above, it may sparse the input scanning lines, so power consumption may be reduced.

In accordance with this embodiment, although there is provided only one display input apparatus, when the display input apparatus is operated by an operator as a POS terminal during a settlement, a service settlement screen can be displayed, and the settlement content can be confirmed by the customer by changing the angle of the display apparatus (tilting the display apparatus) in other cases, or a screen containing an advertisement or service guidance offered to the customer can be displayed. In these cases, an automatic switch to an appropriate sound in combination with the content of the screen can be carried out.

While certain embodiments have been described, these embodiments have been presented by way of example only, and are not intended to limit the scope of the inventions. Indeed, the novel method or system described herein may be embodied in a variety of other forms. Furthermore, various omissions, substitutions and changes in the form of the novel method or system described herein may be made without departing from the spirit of the invention. The accompanying claims are intended to cover such embodiments or variations thereof as would fall within the scope and spirit of the invention.

What is claimed is:

1. A display input apparatus, rotationally installs a display panel having a touch panel for input on a display unit and for a first user and a second user which are facing each other make the display unit of the display panel possible to face the first user and the second user by rotating the display panel, comprises:
an opposite object sensor configured to detect which is facing the display unit of the display panel, the first user or the second user; and
a main body unit configured to switch the content displayed on the display panel according to the detection result of the opposite object sensor.

2. The display input apparatus according to claim 1, wherein
the main body unit displays a display screen different from the display screen in the case that the display unit faces the first user is displayed on the display unit if the opposite direction of the display unit change from the first user side to the second user side.

3. The display input apparatus according to claim 1, wherein
the main body unit displays a screen containing prepared advertisement content if the display unit faces the second user side.

4. The display input apparatus according to claims 1, wherein
the main body unit makes the brightness of the case that the display unit faces the second user side higher than the case that the display unit faces the first user side.

5. The display input apparatus according to claim 3, wherein
the main body unit outputs a sound information corresponding to the screen containing a prepared advertisement content if the display unit faces the second user side.

6. The display input apparatus according to claims 1, wherein
the main body unit makes the display area of the input button of the touch panel of the case that the display unit faces the second user side bigger than the case that the display unit faces the first user side, and makes the input scan line of the touch panel sparse if the display unit faces the second user side.
